(19) United States
(12) Patent Application Publication
(10) Pub. No.: US 2025/0200152 A1
(43) Pub. Date: Jun. 19, 2025

(54) TWO-LEVEL AUTHENTICATION FOR SECURE ASSETS

(71) Applicant: ASSA ABLOY AB, Stockholm (SE)

(72) Inventor: Adrian Daniel Holom, Graz (AT)

(21) Appl. No.: 18/849,805

(22) PCT Filed: Mar. 24, 2022
(86) PCT No.: PCT/EP2022/057821

§ 371 Date: Sep. 23, 2024

(51) Int. Cl. G06F 21/31

(52) U.S. Cl. CPC G06F 21/31; G06F 2221/2113

(57) ABSTRACT

An access control system, processor-implemented method, and computer readable medium optionally includes an electronic memory and a processor. The processor and computer readable medium are configured to receive a command from a user to access the secure asset, determine access rights by the user to the secure asset, based on the access rights of the user, determine general authentication for the user to access the secure asset, and grant access to the user conditional on the general authentication determined for the user.

### BACKGROUND

Various assets, from physical assets such as buildings, rooms, or objects that may be contained therein, to electronic assets, such as electronic files, are desirably protected from theft, tampering, or other forms of unauthorized access by third parties. Such assets may be protected by any of a variety of mechanisms known in the art, including passwords, biometrics, physical locks, digital keys, and so forth. Such assets may commonly be contained within a structure designed to organize or otherwise divide various assets from one another within a common security framework. Physical structures may include physical files, safety deposit boxes, and the like, while electronic structures may include electronic file systems, databases, and so forth.

### SUMMARY

The following presents a simplified summary of one or more embodiments of the present disclosure in order to provide a basic understanding of such embodiments. This summary is not an extensive overview of all contemplated embodiments and is intended to neither identify key or critical elements of all embodiments nor delineate the scope of any or all embodiments.

An access control system (ACS) may provide the capacity to perform an authentication or even mutual authentication on one side from a user (such as a password, electronic or physical key, biometric presentation, etc.) and a reader (e.g., the ACS itself shall prove its identity and/or make sure the ACS was not compromised) on the other side, and determine if the authentication is authentic and, as a result, grant access to a secure asset to the user. The operations and the sequence of operations by which the ACS determines whether or not the authentication is trustworthy may in part determine the effectiveness of the ACS to prevent hacking, spoofing, or otherwise circumventing the security provided by the ACS. Moreover, a third party seeking to improperly access the secure asset may find the nature of the secure asset structure that contains the secure asset, such as the details of the file system that includes an data structure or its existence, identification information or (other) metadata related thereto to be relevant and of direct interest, either in obtaining information or to seek an alternative way to circumvent the ACS. The sequence by which the ACS is authorizing an authentication may similarly place the secure asset structure generally under the protection provided by the ACS or may leave the secure asset structure open to discovery by a third party.

An ACS has been developed that provides a general authentication of a user to the ACS prior to allowing the user to directly access a secure asset rather than concurrently with accessing the secure asset. In various examples, the general authentication is provided according to or in conjunction with a determination of access rights by the user to the secure asset as a second level of protection. In various examples, general authentication is additionally provided prior to the user being able to access the secure asset structure. In various examples, this additional general authentication is based on or acts in conjunction with privacy protection as a second level of protection and may serve to prevent a potential attacker from accessing the secure asset structure.

### BRIEF DESCRIPTION OF THE SEVERAL VIEWS OF THE DRAWINGS

FIGS. 1A and 1B illustrate the ACS implemented in an physical environment, in an example embodiment.

FIG. 2 illustrates a block diagram schematic of various components of an example ACS.

FIG. 3 is a flowchart for providing security of the secure asset structure and the secure assets by the ACS, in an example embodiment.

FIG. 4 is a simplified relationship of access rights to first and second levels of protection, in an example embodiment.

FIG. 5 is a simplified relationship of privacy protection to first and second levels of protection, in an example embodiment.

FIG. 6 illustrates a sequence of operations between a user and the ACS to provide access to the secure asset structure and the secure asset, in an example embodiment.

FIG. 7 illustrates a sequence of operations between a user and the ACS to provide access to the secure asset, in an example embodiment.

### DETAILED DESCRIPTION

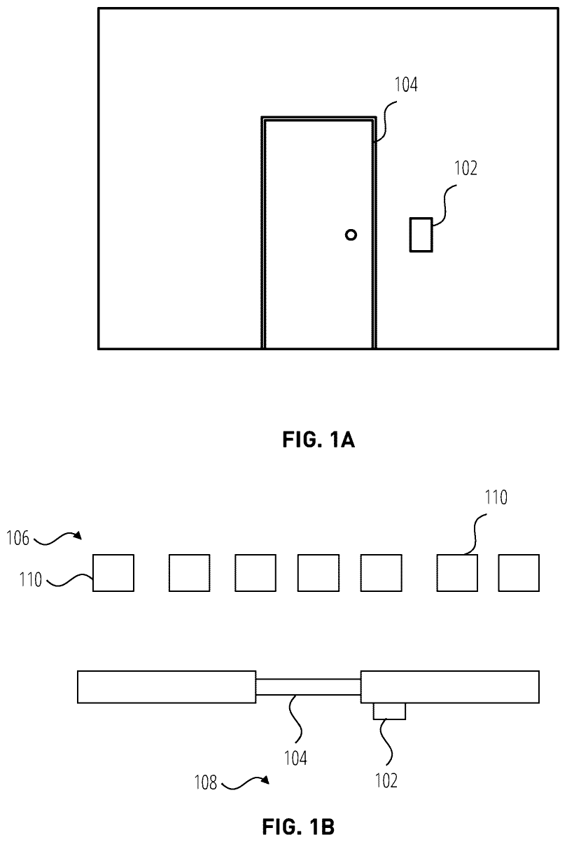

FIGS. 1A and 1B illustrate an ACS 102 implemented in an physical environment, in an example embodiment. In the illustrated example, the ACS 102 is a physical ACS in that the ACS 102 provides access to a secure asset structure 106 that is a physical space or is located in a physical space, such as a room, as illustrated. The ACS 102 controls a locking mechanism on a door 104, the enabling of which prevents someone in an unsecured area 108 from accessing the secure asset structure 106 and the disabling of which allows a subject to open and non-securely pass through the door 104 into or to access the secure asset structure 106. In the illustrated example, the secure asset structure 106 is multiple, individually-accessible secure assets 110 or includes space for such secure assets 110, e.g., the secure asset structure 106 may be a bank vault and the secure assets 110 may be individual safety deposit boxes in the bank vault.

Consequently, the ACS 102 may function to regulate access both to the secure asset structure 106 and to the secure assets 110 within the secure asset structure 106. In the example, a user may provide authentication either using the ACS 102, e.g., by inputting a password or other key, or by electronic communication with the ACS 102, e.g., with a user device, such as a mobile device or other computing or communication device communicating wirelessly with the ACS 102 to transmit credentials (e.g., password(s), key(s), or the like), among other possible mechanisms. Moreover, while the ACS 102 is depicted as being a visible object in relation to the door 104, in various examples in which the ACS 102 is communicating wirelessly with a user device, the ACS 102 may in various examples not have a user interface panel or other visible manifestation.

The ACS 102 may be utilized both to access the secure asset structure 106, e.g., the vault, i.e., as well as the secure assets 110, e.g., the safety deposit boxes, to which the user has personal access. In various examples, the ACS 102 may provide access to one or the other of the secure asset structure 106 and the secure asset 110 but not necessarily both, e.g., because a bank employee provides access to the secure asset structure 106 or the user has a personal key to the secure asset 110. Finally, it is to be recognized and understood that the principles articulated herein may apply to circumstances in which the secure asset structure 106 doesn't exist and that a secure asset 110 exists outside of the context of a wider secure asset structure 106, e.g., because the door 104 provides direct access to the secure asset 110 without further security or organization provided by the secure asset structure 106.

The door 104, secure asset structure 106, and secure assets 110 are presented for illustrative purposes and the door 104 may be any suitable mechanism for restricting access of or to a physical space and that the secure asset structure 106 and/or secure asset 110 may be any physical space or object/objects that may be subject to a need for security or restricted access. Furthermore, while FIGS. 1A and 1B illustrate the ACS 102 in a physical environment, it is to be recognized and understood that the same principles may apply to an electronic or logical environment, e.g., electronic data storage, memory, database, etc. In such an example, the secure asset structure 106 may be an electronic file system, electronic device, or electronic system, while the secure asset 110 may be an electronic file that may be stored in a memory, data storage, or the like. Consequently, for the purposes of this disclosure, the secure asset structure 106 may be understood to be any structure or system for storing physical or electronic objects while the secure asset 110 may be understood to be any physical, electronic, or logical item or collection of items that may have limited and controllable access.

Moreover, the secure asset structure 106 may provide or provide the basis for metadata related to some or all of the secure assets 110. For instance, the secure asset structure 106 may include an individual address of some or all of the secure assets 110 and/or may include information about some or all of the secure assets 110. Such information may relate to a name of the secure asset 110, a type, e.g., file type, of the secure asset 110, a size of the secure asset 110, a date on which the secure asset 110 was created, stored, last accessed, etc., and an owner of the secure asset 110, among other information. Therefore, the capacity of a user of the ACS 102 to access the secure asset structure 106 without necessarily the capacity to access individual secure assets 110 may nonetheless provide potentially valuable information about the secure assets 110 contained within the secure asset structure 106, including addresses by which a potential attacker may seek to access the secure asset 110 directly without respect to the secure asset structure 106.

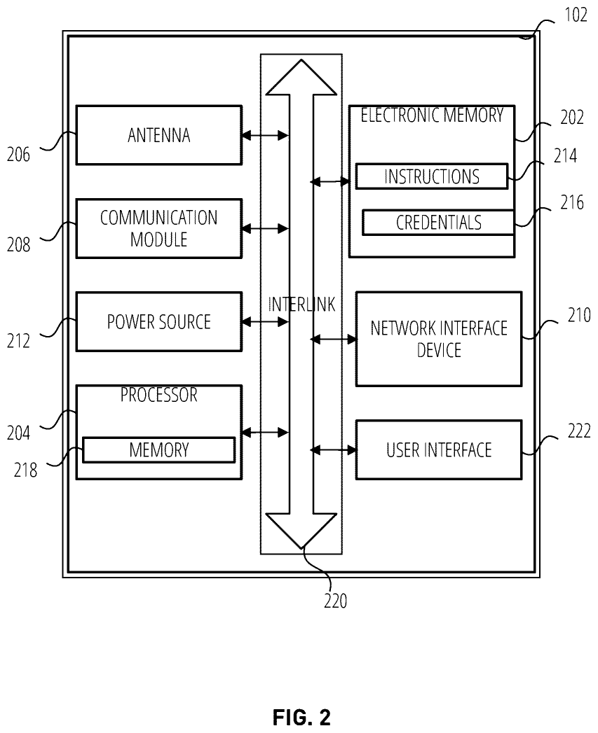

FIG. 2 illustrates a block diagram schematic of various components of an example ACS 102. In general, the ACS 102 can include one or more of an electronic memory 202, a processor 204, one or more antenna 206, a communication module 208, a network interface device 210, a user interface 222, and a power source 212.

The electronic memory 202 can be used in connection with the execution of application programming or instructions by the processor 204, and for the temporary or long-term storage of program memory 218 and/or credentials 216 or other authorization data, such as credential data, credential authorization data, or access control data or instructions. For example, the electronic memory 202 can contain executable instructions 214 that are used by the processor 204 to run other components of the ACS 102 and/or to make access determinations based on credentials 216. The electronic memory 202 can comprise a computer readable medium that can be any medium that can contain, store, communicate, or transport data, program code, or instructions for use by or in connection with processor 204 specifically or the ACS 102 generally. The computer readable medium can be, for example but is not limited to, an electronic, magnetic, optical, electromagnetic, infrared, or semiconductor system, apparatus, or device. More specific examples of suitable computer readable medium include, but are not limited to, an electrical connection having one or more wires or a tangible storage medium such as a portable computer diskette, a hard disk, a random access memory (RAM), a read-only memory (ROM), an erasable programmable read-only memory (EPROM or Flash memory), Dynamic RAM (DRAM), any solid-state storage device, in general, a compact disc read-only memory (CD-ROM), or other optical or magnetic storage device. Computer-readable media includes, but is not to be confused with, computer-readable storage medium, which is intended to cover all physical, non-transitory, or similar embodiments of computer-readable media.

The processor 204 can correspond to one or more computer processing devices or resources. For instance, the processor 204 can be provided as silicon, as a Field Programmable Gate Array (FPGA), an Application-Specific Integrated Circuit (ASIC), any other type of Integrated Circuit (IC) chip, a collection of IC chips, or the like. As a more specific example, the processor 204 can be provided as a microprocessor, Central Processing Unit (CPU), or plurality of microprocessors or CPUs that are configured to execute instructions sets stored in a memory 218 and/or the electronic memory 202.

The antenna 206 can correspond to one or multiple antennas and can be configured to provide for wireless communications between the ACS 102 and a credential or key device. The antenna 206 or antennas can be arranged to operate using one or more wireless communication protocols and operating frequencies including, but not limited to, the IEEE 802.15.1, Bluetooth, Bluetooth Low Energy (BLE), near field communications (NFC), ZigBee, GSM, CDMA, Wi-Fi, RF, UWB, and the like. By way of example, the antenna 206 can be RF antenna(s), and as such, may transmit/receive RF signals through free-space to be received/transferred by a credential or key device having an RF transceiver. In some cases, at least one antenna 206 is an antenna designed or configured for transmitting and/or receiving UWB signals (referred to herein for simplicity as a “UWB antenna”) such that the reader can communicate using UWB techniques. The communication module 208 can be configured to communicate according to any suitable communications protocol with one or more different systems or devices either remote or local to the ACS 102.

The network interface device 210 includes hardware to facilitate communications with other devices over a communication network utilizing any one of a number of transfer protocols (e.g., frame relay, internet protocol (IP), transmission control protocol (TCP), user datagram protocol (UDP), hypertext transfer protocol (HTTP), etc.). Example communication networks can include a local area network (LAN), a wide area network (WAN), a packet data network (e.g., the Internet), mobile telephone networks (e.g., cellular networks), Plain Old Telephone (POTS) networks, wireless data networks (e.g., networks based on the IEEE 802.11 family of standards known as Wi-Fi or the IEEE 802.16 family of standards known as WiMax), networks based on the IEEE 802.15.4 family of standards, and peer-to-peer (P2P) networks, among others. In some examples, network interface device 210 can include an Ethernet port or other physical jack, a Wi-Fi card, a Network Interface Card (NIC), a cellular interface (e.g., antenna, filters, and associated circuitry), or the like. In some examples, network interface device 210 can include a plurality of antennas to wirelessly communicate using at least one of single-input multiple-output (SIMO), multiple-input multiple-output (MIMO), or multiple-input single-output (MISO) techniques.

The user interface 222 can include one or more input devices and/or output devices. Examples of suitable user input devices that can be included in the user interface 222 include, without limitation, one or more buttons, a keyboard, a mouse, a touch-sensitive surface, a stylus, a camera, a microphone, fingerprint sensor, vein reading sensor, etc. Examples of suitable user output devices that can be included in the user interface 222 include, without limitation, one or more LEDs, a LCD panel, a display screen, a touchscreen, one or more lights, a speaker, etc. It should be appreciated that the user interface 222 can also include a combined user input and user output device, such as a touch-sensitive display or the like.

The power source 212 can be any suitable internal power source, such as a battery, capacitive power source or similar type of charge-storage device, etc., and/or can include one or more power conversion circuits suitable to convert external power into suitable power (e.g., conversion of externally-supplied AC power into DC power) for components of the ACS 102. The power source 212 can also include some implementation of surge protection circuitry to protect the components of the ACS 102 from power surges.

ACS 102 can also include one or more interlink 220 operable to transmit communications between the various hardware components of the reader. A system interlink 220 can be any of several types of commercially available bus structures or bus architectures.

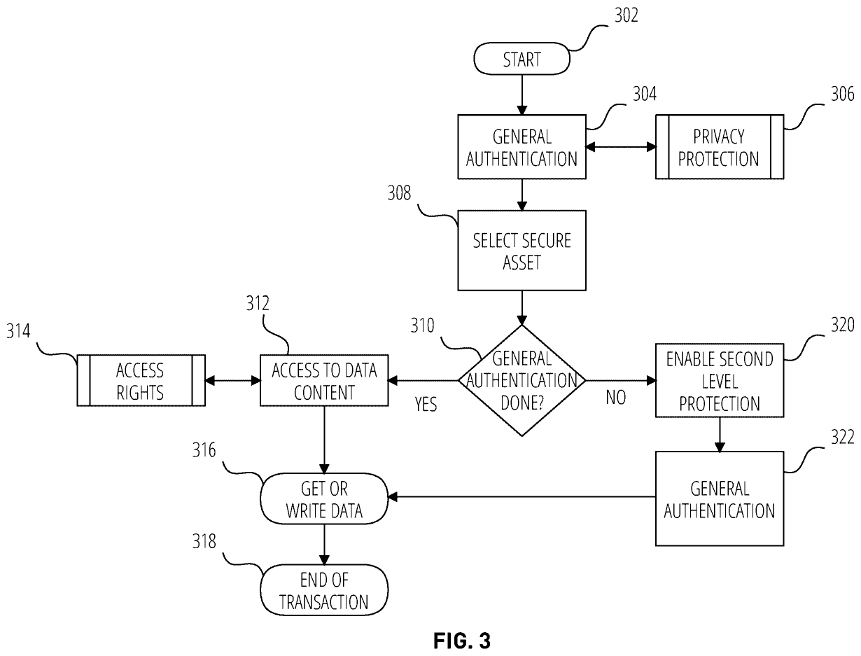

FIG. 3 is a flowchart for providing security of the secure asset structure 106 and the secure assets 110 by the ACS 102, in an example embodiment. The process and operations of the flowchart may be utilized by the ACS 102 for any purpose described herein or any other suitable purpose to which the ACS 102 may be applied.

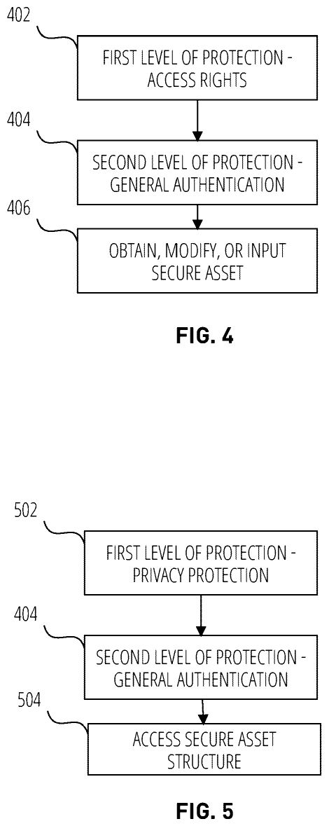

At 302, the ACS 102 starts the process. In various examples, the ACS 102 provides an interface, either on the user interface 222 of the ACS 102 itself or wirelessly on a personal device of the user. The interface may allow a user to input a password or key, view a representation of the secure asset structure 106, and/or select a secure asset 110. However, as will be described in detail herein, such information may not necessarily be presented at the start operation 302 but may instead be made available over the course of the flowchart as authentication is provided and privacy protection maintained. Concepts of privacy protection, access rights, and general authentication will be discussed in detail with respect to FIG. 4 and FIG. 5.

At 304, the ACS 102 optionally performs general authentication and, at 306, privacy protection analysis based on whether or not the user is seeking to access the secure asset structure 106.

At 308, a user selects a secure asset 110 from the secure asset structure 106 via the ACS 102 based on the provision of general authentication at 304 and privacy protection at 306. In circumstances where user has not or has not yet met the criteria for the privacy protection at 304, the ACS 102 may withhold some or all information about the the secure asset structure 106 or which may inferred from the secure asset structure 106, such as metadata, the file structure, the identity of the secure assets 110, etc.

At 310, the ACS 102 determines if general authentication has been executed, e.g., by the user and/or if the ACS 102 has performed or determined general authentication of the user, as will be disclosed in detail herein. If general authentication has been performed by and/or determined for the user, then the ACS 102 proceeds to operation 312. If general authentication has not been doneby and/or determined for the user, then then ACS 102 proceeds to operation 320.

At 312, the ACS 102 provides access to the secure asset structure 106 and to the secure asset 110, dependent on the access rights associated with the user as determined by the ACS 102 at operation 314. At 316 the user is able to read information from or write information to a particular secure asset 110 based on the corresponding access rights. After completing their interaction with the secure asset 110, the user may cause the ACS 102 to proceed to 318 and end the transaction, or the ACS 102 may default to proceed to 318 and end the transaction, e.g., based on user inactivity. Following 318, the ACS 102 may proceed back to 302.

At 320, where general authentication was not established at 310, the ACS 102 proceeds to enable the second level of protection. At 322, the ACS 102 performs a second general authentication. On the basis of the general authentication, the ACS 102 proceeds to 316.

In general, the privacy protection 306 and the access rights 314 operations may be understood to constitute a first layer of protection by the ACS 102 for the secure asset structure 106 and the secure assets 110. The determination of general authentication at 310, 320, and 322 constitutes a second layer of protection by the ACS 102 for the secure asset structure 106 and the secure assets 110. The second layer of protection may provide protection for the secure asset structure 106 in particular and seek to prevent an attacker from being able to access information in the secure asset structure 106, as disclosed herein. While the flowchart of FIG. 3 provides two first levels of protection, i.e., privacy protection at 306 and access rights at 314, in various examples the ACS 102 may provide a first level of protection with one or the other of privacy protection and access rights but not necessarily both or it might provide a second level of protection by conducting general authentication at 322 before the 308 selection of the secure asset 110.

FIG. 4 is a simplified relationship of access rights to first and second levels of protection, in an example embodiment. At 402, a first level of protection is provided by controlling access rights to an individual secure asset 110. For the purposes of this disclosure, the control of access rights may be any operation that controls of the ability of users to access, read, write to, and/or delete a secure asset 110 depending on the configuration. As such, access rights define the permissions possessed by a user (e.g., a person, a device, an organization, etc.) to perform actions in relation to a given secure asset 110. An access rights configuration itself can be read or written based on the access rights of a user or a key utilized by a user. Consequently, where the first level of protection 402 is based on access rights, the owner of a secure asset 110 or the ACS 102 generally may determine the permissions for a secure asset 110 and what operations any given user can perform on the secure asset 110.

In various examples, ACS 102 may perform access rights analysis on the basis of one or more predetermined keys or other authentication mechanisms that may be presented by or from the user to the ACS 102. In an example, one key may provide for read access to a particular secure asset 110, a second key may provide for write access to the secure asset 110, and a third key may provide read and write access to the secure asset 110. The ACS 102 may grant such access as the received key allows. The ACS 102 may either deny access or provide fake or decoy access to a false secure asset 110 in the event of a failed attempt to pass access rights by a user.

At 404, a second level of protection may be based on general authentication. For the purposes of this disclosure, general authentication may be any process or action of proving or showing something to be true, genuine, or valid through the use of mutual authentication, e.g., in which both the user and the ACS 102 prove to the other that each is genuine. Thus, in an example where a user is attempting to interface with the ACS 102, e.g., to access a particular secure asset 110, using an application on a smartphone, the ACS 102 may utilize any process that allows the smartphone to authenticate itself and/or the user to the ACS 102 and the that allows the ACS 102 to authenticate itself to the smartphone.

At 406, based on passing both the first level of protection 402 and the second level of protection 404, the ACS 102 provides access to the user to the secure asset 110 based on the access rights associated with the user to that secure asset 110. However, the ACS 102 may not necessarily allow the user to access the secure asset structure 106 and/or metadata related to individual secure assets 110 that are not the secure asset 110 to which the user has been granted access.

FIG. 5 is a simplified relationship of privacy protection to first and second levels of protection, in an example embodiment. At 502, a first level of protection is provided through privacy protection mechanisms. Such privacy protection mechanisms may seek to provide acceptable levels of privacy as to the secure asset structure 106, such that a user that lacks suitable authorization may not be able to determine the nature of the secure asset structure 106, e.g., may not know which secure assets 110 are in the secure asset structure 106 and/or the organization of those secure assets 110.

Consequently, the secure assets 110 and information related to the secure assets 110 and their respective owners may not be trackable or identifiable. Privacy protection may be provided by the use of random identifiers rather than predetermined unique identifiers, encrypted communications, or any other suitable mechanisms.

The ACS 102 may perform privacy protection by establishing a predetermined key or other authentication mechanism. In various examples, if a user presents a key that is not being used by the ACS 102 for privacy protection for a given secure asset structure 106 then the ACS 102 does not provide access to the secure asset structure 106 or to metadata or other information concerning the secure asset structure 106 to the user. In various examples, an error may be returned to the user or the ACS 102 may behave in a way to spoof the user into thinking that access to the secure asset structure 106 has been granted but in fact false access and/or false information relating to the secure asset structure 106 is presented to the use instead of authentic access and/or information, e.g., a decoy.

At 404, the ACS 102 provides the second level of protection according to general authentication, as described in FIG. 4. At 504, based on a user having met both privacy protection and general authentication, the ACS 102 provides access to the secure asset structure 106 but does not necessarily allow a user to access or perform operations on any individual secure asset 110.

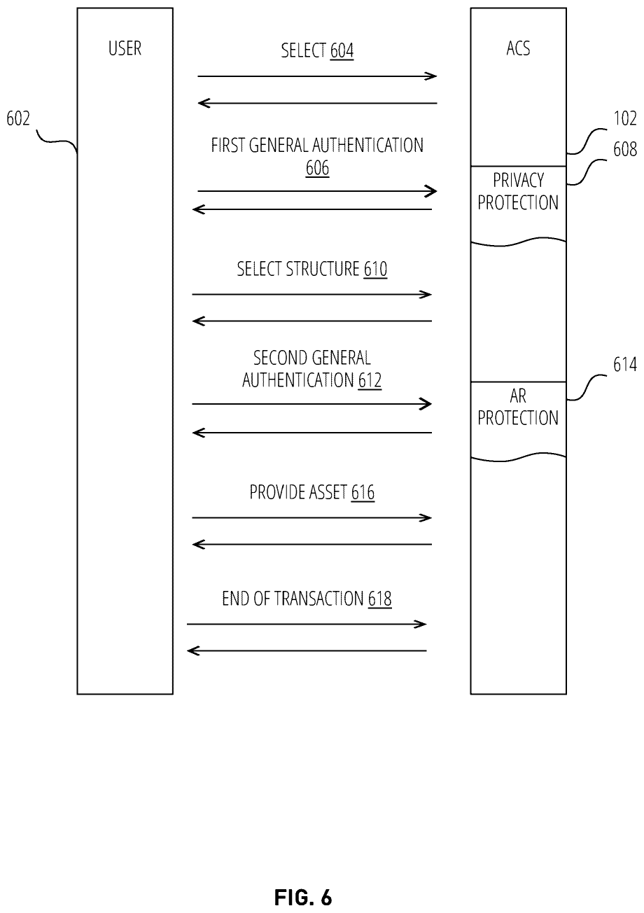

FIG. 6 illustrates a sequence of operations between a user 602 and the ACS 102 to provide access to the secure asset structure 106 and the secure asset 110, in an example embodiment. The user 602 may utilize a personal device, as described herein, or may utilize the user interface 222 of the ACS 102 to provide data and responses. Alternatively, a device of the user may automatically provide such information based on previous instructions from the user, proximity of the user device to the ACS 102, etc., i.e., the responses are not necessarily prompted responses from a user.

In the illustrated, example, general authentication to provide for access to both the secure asset structure 106 and to the secure asset 110 is broken into two steps, with general authentication performed before selection of the secure asset structure 106 so that a user who doesn't know the identification of a particular secure asset 110 may be inhibited from inputting a random identification for a secure asset 110 without a first successful general authentication followed by a second general authentication establishing the right access for the particular secure asset 110.

At 604, the user 602 starts by optionally selecting to begin the process of communicating with the ACS 102 or otherwise initiate an attempt to access the secure asset structure 106 and/or a secure asset 110, to which the ACS 102 may respond with a command response or with a prompting message.

At 606, the ACS 102 engages in a first general authentication 606 based on privacy protection as illustrated in FIG. 5 and as implemented at 608 that may enable the access to the features that ACS 102 provides and potentially the secure asset structure 106. As such, the first general authentication 606 includes first implementing privacy protection as the first level of protection 502 and then general authentication as the second level of protection 404.

At 610, based on having obtained the first general authentication at 606, the ACS 102 provides information about the secure asset structure 106. The user may also select a secure asset 110 within the secure asset structure 106.

At 612, based on the user 602 having selected a secure asset 110, the ACS 102 engages in second general authentication 612 based on access rights as illustrated in FIG. 4 and as implemented at 614. In various examples, the second general authentication 612 is the same command by the ACS 102 as the first general authentication 606 but, as noted, is related to access rights protection rather than privacy protection. The command to perform the second general authentications may be protected by secure messaging or other mechanism for encrypting the commands, e.g., with a session key or other suitable mechanism. For symmetric or asymmetric cryptography, each general authentication command may include a command and a response. As such, the second general authentication 612 includes first checking access control as the first level of protection 402 and then the rest of general authentication process to form the second level of protection 404.

At 616, the ACS 102 provides access to the secure asset 110 as selected to the user 602. The user 602 may be enabled to read, write to, delete, or remove the secure asset 110 data content and/or structure depending on the access rights of the user 602.

At 618, the user 602 either chooses to end the transaction or the ACS 102 ends the transaction, e.g., because of a timeout clause. Otherwise, the user 602 may also start a new communication, e.g. pulling out and in an RF field the user device, and starting a new transaction with 604.

The select structure operation 610 and the second general authentication 612 may be either symmetric authentication or asymmetric authentication, and the select structure 610 and second general authentication 612 do not necessarily need to both be symmetric or asymmetric. In the case of symmetric authentication, general authentication may be performed, e.g., as a secret key held between the ACS 102 and the user 602. For instance, the ACS 102 may generate a random number to which the user 602 applies the secret key to determine the random number. In the case of asymmetric authentication, the ACS 102 may utilize a private/public key structure or any other suitable mechanism. In various examples, symmetric or asymmetric authentication may be applied to operations 604 and 606.

While the operations are described as having been performed by the ACS 102 specifically, it is to be recognized and understood that in various examples the ACS 102 may facilitate engagement with, e.g., the secure asset structure 106 and the secure asset 110. However, in circumstances where the ACS 102 has determined general authentication, privacy protection, and/or access rights, the ACS 102 may provide for direct engagement with the secure asset structure 106 or the associated secure asset 110. Thus, in various examples, the operations 610 and 616 may not necessarily be conducted via the ACS 102 but rather on the basis of the permissions determined by the ACS 102. Thus, the operation 610 may be performed by or through the secure asset structure 106 and the operation 616 may be performed by or through the secure asset 110.

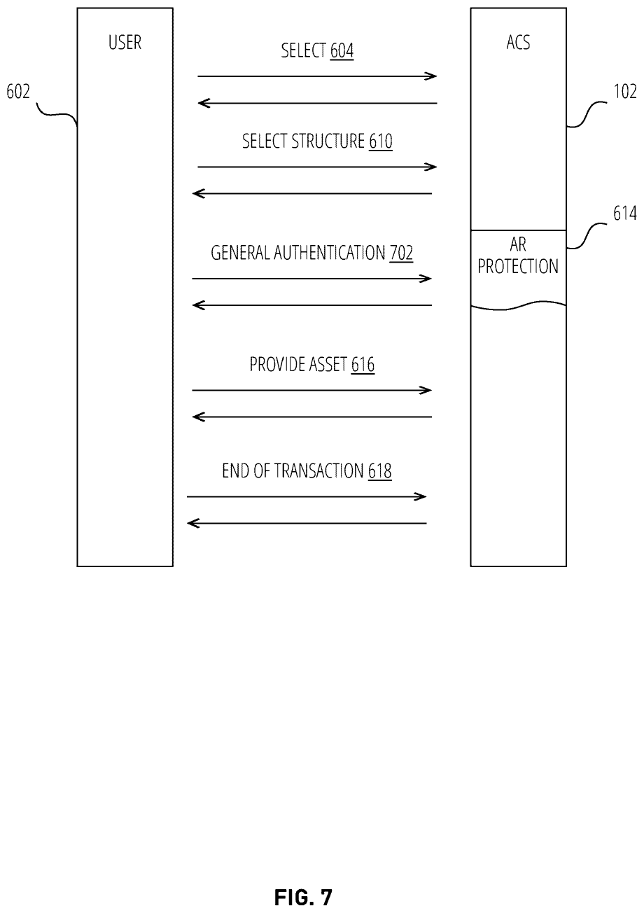

FIG. 7 illustrates a sequence of operations between a user 602 and the ACS 102 to provide access to the secure asset 110, in an example embodiment. The user 602 may utilize a personal device, as described herein, or may utilize the user interface 222 of the ACS 102 to provide data and responses. Alternatively, a device of the user may automatically provide such information based on previous instructions from the user, proximity of the user device to the ACS 102, etc., i.e., the responses are not necessarily prompted responses from a user.

The sequence differs from the sequence of FIG. 6 in that the ACS 102 does not necessarily seek to protect the secure asset structure 106 and consequently does not necessarily utilize privacy protection. The sequence of FIG. 7 otherwise utilizes the same or similar operations as the sequence of FIG. 6 where the reference numerals are the same below.

At 604 the user 602 starts by optionally selecting to begin the process or otherwise initiate an attempt to access the secure asset structure 106 and/or a secure asset 110, to which the ACS 102 responds.

At 610, based on having obtained the first general authentication, the user 602 selects a secure asset structure 106 and the ACS 102 provides information about the secure asset structure 106. The user may also select a secure asset 110 within the secure asset structure 106.

At 702, based on the user 602 having selected a secure asset 110, the ACS 102 engages in general authentication 702 based on access rights as illustrated in FIG. 4. In various examples, the ACS 102 utilizes an authentication key which has been assigned, e.g., previously by the ACS 102, to provide for reading a secure asset 110, to write to the secure asset 110, and/or to read and write to the secure asset 110.

At 616, the ACS 102 provides the secure asset 110 as selected to the user 602. The user 602 may be enabled to read, write to, delete, or remove the secure asset 110 depending on the rights of the user 602.

At 618, the user 602 either chooses to end the transaction or the ACS 102 ends the transaction, e.g., because of a timeout clause, terminating wireless link between a user device and the ACS 102, or any other suitable mechanism. Additionally, the user may start a new communication session with the ACS 102, e.g., by terminating the wireless link and restarting the process or by starting a new transaction at 604.

The operations of FIG. 7 illustrate the provision of general authentication and access rights without respect to the privacy protection. It is to be recognized and understood that the principles disclosed with respect to 702 may be applied to privacy protection instead of access rights, with the resultant change that the user may access the secure asset structure 106 but not necessarily be given access to a secure asset 110. Moreover, the operations of FIG. 7 may optionally be modified to include the first general authentication 606 before the operation 702 and thereby provide both access rights and privacy protection.

### EXAMPLES

Example 1 is an access control system (ACS) configured to control access to a secure asset, comprising: an electronic memory configured to an authentication mechanism; a processor, operatively coupled to the electronic memory, configured to: receive a command from a user to access the secure asset; determine access rights by the user to the secure asset; based on the access rights of the user, determine general authentication for the user to access the secure asset; and grant access to the user conditional on the general authentication determined for the user.

In Example 2, the subject matter of Example 1 includes, wherein the secure asset is organized within a secure asset structure, wherein the general authentication is a second general authentication, and wherein the processor is further configured to: receive a command from the user to access the secure asset structure; determine if the user meets a privacy protection criterion for the secure asset structure; based on the privacy protection criterion, determine a first general authentication for the user to access the secure asset structure; and grant access to the user to the secure asset structure based on the first general authentication being granted to allow the user to enter the command to access the secure asset.

In Example 3, the subject matter of any one or more of Examples 1 and 2 includes, wherein the processor is configured to grant the user access to the secure asset structure by providing an identifier of the secure asset.

In Example 4, the subject matter of any one or more of Examples 1 through 3 includes, wherein the secure asset structure is configured to organize a plurality of secure assets, wherein the second general authentication is configured to provide access to discrete ones of the plurality of secure assets.

In Example 5, the subject matter of any one or more of Examples 1 through 4 includes, wherein the processor is configured to grant access to the user to the secure asset structure by providing information concerning the plurality of secure assets to the user.

In Example 6, the subject matter of any one or more of Examples 1 through 5 includes, wherein the information is at least one of metadata and an identifier of the secure asset.

In Example 7, the subject matter of any one or more of Examples 1 through 6 includes, wherein the access rights are at least one of: write authority, read authority, or both.

Example 8 is a processor-implemented method of controlling access to a secure asset, comprising: receiving a command from a user to access the secure asset; determining access rights by the user to the secure asset; based on the access rights of the user, determining general authentication for the user to access the secure asset; and granting access to the user conditional on the general authentication determined for the user.

In Example 9, the subject matter of Example 8 includes, wherein the secure asset is organized within a secure asset structure, wherein the general authentication is a second general authentication, and further comprising: receiving a command from the user to access the secure asset structure; determining if the user meets a privacy protection criterion for the secure asset structure; based on the privacy protection criterion, determining a first general authentication for the user to access the secure asset structure; and granting access to the user to the secure asset structure based on the first general authentication being granted to allow the user to enter the command to access the secure asset.

In Example 10, the subject matter of any one or more of Examples 8 and 9 includes, wherein granting the user access to the secure asset structure is by providing an identifier of the secure asset.

In Example 11, the subject matter of any one or more of Examples 8 through 10 includes, wherein the secure asset structure is configured to organize a plurality of secure assets, wherein the second general authentication is configured to provide access to discrete ones of the plurality of secure assets.

In Example 12, the subject matter of any one or more of Examples 8 through 11 includes, wherein granting access to the user to the secure asset structure is by providing information concerning the plurality of secure assets to the user.

In Example 13, the subject matter of any one or more of Examples 8 through 12 includes, wherein the information is at least one of metadata and an identifier of the secure asset.

In Example 14, the subject matter of any one or more of Examples 8 through 13 includes, wherein the access rights are at least one of: write authority, read authority, or both.

Example 15 is a computer readable medium comprising instructions which, when implemented by a processor, cause the processor to perform operations comprising: receiving a command from a user to access the secure asset; determining access rights by the user to the secure asset; based on the access rights of the user, determining general authentication for the user to access the secure asset; and granting access to the user conditional on the general authentication determined for the user.

In Example 16, the subject matter of Example 15 includes, wherein the secure asset is organized within a secure asset structure, wherein the general authentication is a second general authentication, and wherein the instructions further cause the processor to perform operations comprising: receiving a command from the user to access the secure asset structure; determining if the user meets a privacy protection criterion for the secure asset structure; based on the privacy protection criterion, determining a first general authentication for the user to access the secure asset structure; and granting access to the user to the secure asset structure based on the first general authentication being granted to allow the user to enter the command to access the secure asset.

In Example 17, the subject matter of any one or more of Examples 15 and 16 includes, wherein granting the user access to the secure asset structure is by providing an identifier of the secure asset.

In Example 18, the subject matter of any one or more of Examples 15 through 17 includes, wherein the secure asset structure is configured to organize a plurality of secure assets, wherein the second general authentication is configured to provide access to discrete ones of the plurality of secure assets.

In Example 19, the subject matter of any one or more of Examples 15 through 18 includes, wherein granting access to the user to the secure asset structure is by providing information concerning the plurality of secure assets to the user.

In Example 20, the subject matter of any one or more of Examples 15 through 19 includes, wherein the information is at least one of metadata and an identifier of the secure asset.

In Example 21, the subject matter of any one or more of Examples 15 through 20 includes, wherein the access rights are at least one of: write authority, read authority, or both.

Example 22 is an apparatus comprising means to implement of any of Examples 1-21.

Example 23 is a system to implement of any of Examples 1-21.

Example 24 is a method to implement of any of Examples 1-21.

What is claimed is:

1. An access control system (ACS) configured to control access to a secure asset, comprising:
an electronic memory configured to an authentication mechanism;
a processor, operatively coupled to the electronic memory, configured to:
receive a command from a user to access the secure asset;
determine access rights by the user to the secure asset;
based on the access rights of the user, determine general authentication for the user to access the secure asset; and
grant access to the user conditional on the general authentication determined for the user.

2. The access control system of claim 1, wherein the secure asset is organized within a secure asset structure, wherein the general authentication is a second general authentication, and wherein the processor is further configured to:
receive a command from the user to access the secure asset structure;
determine if the user meets a privacy protection criterion for the secure asset structure;
based on the privacy protection criterion, determine a first general authentication for the user to access the secure asset structure; and
grant access to the user to the secure asset structure based on the first general authentication being granted to allow the user to enter the command to access the secure asset.

3. The access control system of claim 2, wherein the processor is configured to grant the user access to the secure asset structure by providing an identifier of the secure asset.

4. The access control system of claim 3, wherein the secure asset structure is configured to organize a plurality of secure assets, wherein the second general authentication is configured to provide access to discrete ones of the plurality of secure assets.

5. The access control system of claim 4, wherein the processor is configured to grant access to the user to the secure asset structure by providing information concerning the plurality of secure assets to the user.

6. The access control system of claim 5, wherein the information is at least one of metadata and an identifier of the secure asset.

7. The access control system of claim 1, wherein the access rights are at least one of: write authority, read authority, or both.

8. A processor-implemented method of controlling access to a secure asset, comprising:
receiving a command from a user to access the secure asset;
determining access rights by the user to the secure asset;
based on the access rights of the user, determining general authentication for the user to access the secure asset; and
granting access to the user conditional on the general authentication determined for the user.

9. The processor-implemented method of claim 8, wherein the secure asset is organized within a secure asset structure, wherein the general authentication is a second general authentication, and further comprising:
receiving a command from the user to access the secure asset structure;
determining if the user meets a privacy protection criterion for the secure asset structure;
based on the privacy protection criterion, determining a first general authentication for the user to access the secure asset structure; and
granting access to the user to the secure asset structure based on the first general authentication being granted to allow the user to enter the command to access the secure asset.

10. The processor-implemented method of claim 9, wherein granting the user access to the secure asset structure is by providing an identifier of the secure asset.

11. The processor-implemented method of claim 10, wherein the secure asset structure is configured to organize a plurality of secure assets, wherein the second general authentication is configured to provide access to discrete ones of the plurality of secure assets.

12. The processor-implemented method of claim 11, wherein granting access to the user to the secure asset structure is by providing information concerning the plurality of secure assets to the user.

13. The processor-implemented method of claim 12, wherein the information is at least one of metadata and an identifier of the secure asset.

14. The processor-implemented method of claim 8, wherein the access rights are at least one of: write authority, read authority, or both.

15. A computer readable medium comprising instructions which, when implemented by a processor, cause the processor to perform operations comprising:
receiving a command from a user to access the secure asset;
determining access rights by the user to the secure asset;
based on the access rights of the user, determining general authentication for the user to access the secure asset; and
granting access to the user conditional on the general authentication determined for the user.

16. The computer readable medium of claim 15, wherein the secure asset is organized within a secure asset structure, wherein the general authentication is a second general authentication, and wherein the instructions further cause the processor to perform operations comprising:
receiving a command from the user to access the secure asset structure;
determining if the user meets a privacy protection criterion for the secure asset structure;
based on the privacy protection criterion, determining a first general authentication for the user to access the secure asset structure; and
granting access to the user to the secure asset structure based on the first general authentication being granted to allow the user to enter the command to access the secure asset.

17. The computer readable medium of claim 16, wherein granting the user access to the secure asset structure is by providing an identifier of the secure asset.

18. The computer readable medium of claim 17, wherein the secure asset structure is configured to organize a plurality of secure assets, wherein the second general authentication is configured to provide access to discrete ones of the plurality of secure assets.

19. The computer readable medium of claim 18, wherein granting access to the user to the secure asset structure is by providing information concerning the plurality of secure assets to the user.

20. The computer readable medium of claim 19, wherein the information is at least one of metadata and an identifier of the secure asset.

21. The computer readable medium of claim 15, wherein the access rights are at least one of: write authority, read authority, or both.
